(19) United States
(12) Patent Application Publication
(10) Pub. No.: US 2004/0125240 A1
(43) Pub. Date: Jul. 1, 2004

(54) Integrated tuner circuit

(76) Inventors: Edward Ferdinand Stikvoort, Eindhoven (NL); Jan Van Sinderen, Eindhoven (NL); Leonardus Ruitenburg, Swalmen (NL); Arie Kuehn, Den Haag (NL); Gerardus Christiaan Maria Gielis, Weert (NL); Marc Godfriedus Marie Notten, Eindhoven (NL); Antoon Marie Henrie Tombeur, Eindhoven (NL); Gerardus Marie Dionysius Jeurissen, Eindhoven (NL)

Correspondence Address: Steven R Biren, US Philips Corporation, Intellectual Property Department, P O Box 3001, Briarcliff Manor, NY, 10510, US

(21) Appl. No.: 10/476,966

(22) PCT Filed: May 8, 2002
(86) PCT No.: PCT/IB02/01625

(30) Foreign Application Priority Data
May 11, 2001 (EP) 01201757.0

(51) Int. Cl. H04N 5/50

(52) U.S. Cl. 348/731

(57) ABSTRACT

The invention relates to an integrated tuner circuit, preferably to a TV-tuner circuit using double conversion.

It is a major purpose of the invention to modify a prior art tuner circuit in a way such that a high degree of integration is achieved. This is contrary to the state of the art in which tuners comprise many discrete components and comprise a lot of adjusting and alignment points. A high degree of integration will substantially reduce the costs, not only production costs but also costs accompanying the complex adjusting procedure. Also, by increasing the degree of integration dimensions may be substantially reduced.

In view of the above purpose the invention provides an integrated tuner circuit having a first polyphase filter (10) at the input side of a fully complex mixer (13), and a second polyphase filter (15) at the output of the fully complex mixer (13).

The invention relates to an integrated tuner circuit. A preferred embodiment relates to a TV-tuner circuit using double conversion.

Such a tuner is known from e.g. U.S. Pat. No. 6,016,170, U.S. Pat. No. 5,200,826, U.S. Pat. No. 4,581,643, U.S. Pat. No. 5,270,824, U.S. Pat. No. 5,179,726 and U.S. Pat. No. 3,939,429.

It is an object of the invention to modify a prior art tuner circuit in a way such that a high degree of integration is achieved. This is contrary to the state of the art in which tuners comprise many discrete components and comprise a lot of adjusting and alignment points. A high degree of integration will substantially reduce the costs, not only production costs but also costs accompanying the complex adjusting procedure. Also, by increasing the degree of integration, dimensions may be substantially reduced.

In view of the above purpose the invention provides an integrated tuner circuit, a tuner module, and a television signal receiver as defined by the independent claims. More specifically, the invention provides an integrated tuner circuit having a first polyphase filter at the input side of a fully complex mixer, and a second polyphase filter at the output of the fully complex mixer. The dependent claims define advantageous embodiments.

Most benefit according to the invention is obtained by implementing the specified part of the tuner as an integrated circuit. The tuner circuit is advantageously applied in a TV signal receiver, such as a video tape recorder, a TV set, a set-top box, or in a cable modem.

These and other aspects of the invention will now be explained with reference to the accompanying drawings, in which:

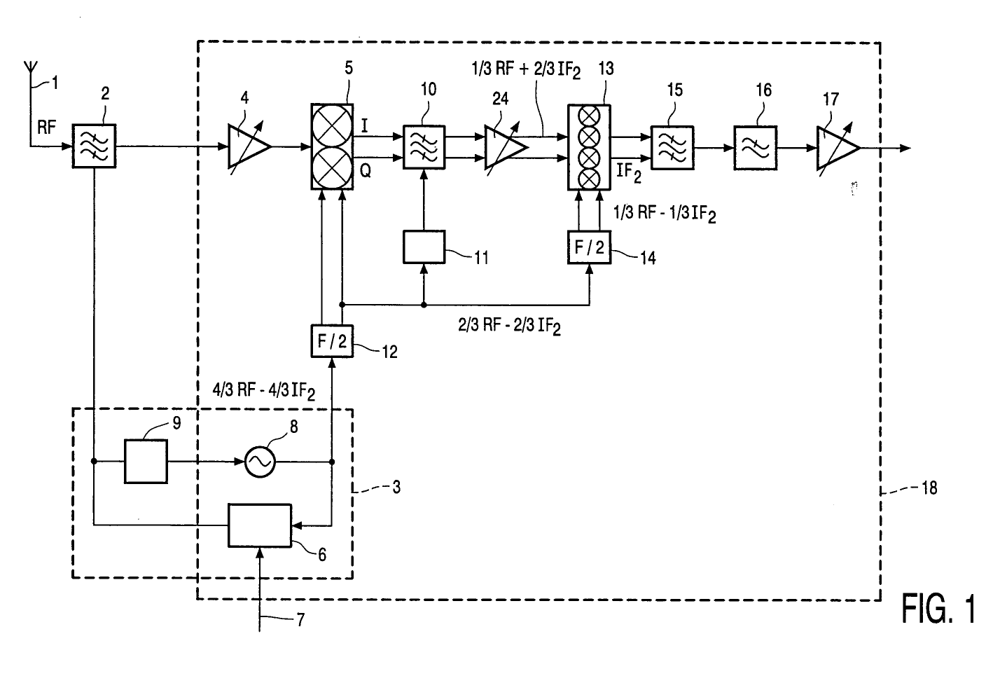

FIG. 1 shows a block schematic diagram of a first embodiment of the tuner according to the invention;

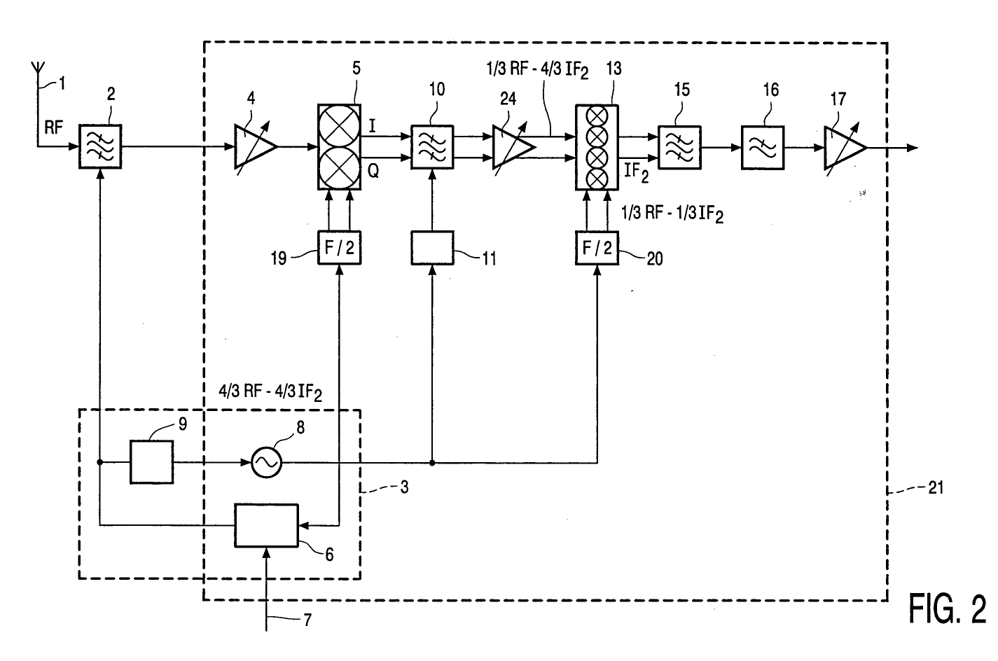

FIG. 2 shows a second embodiment;

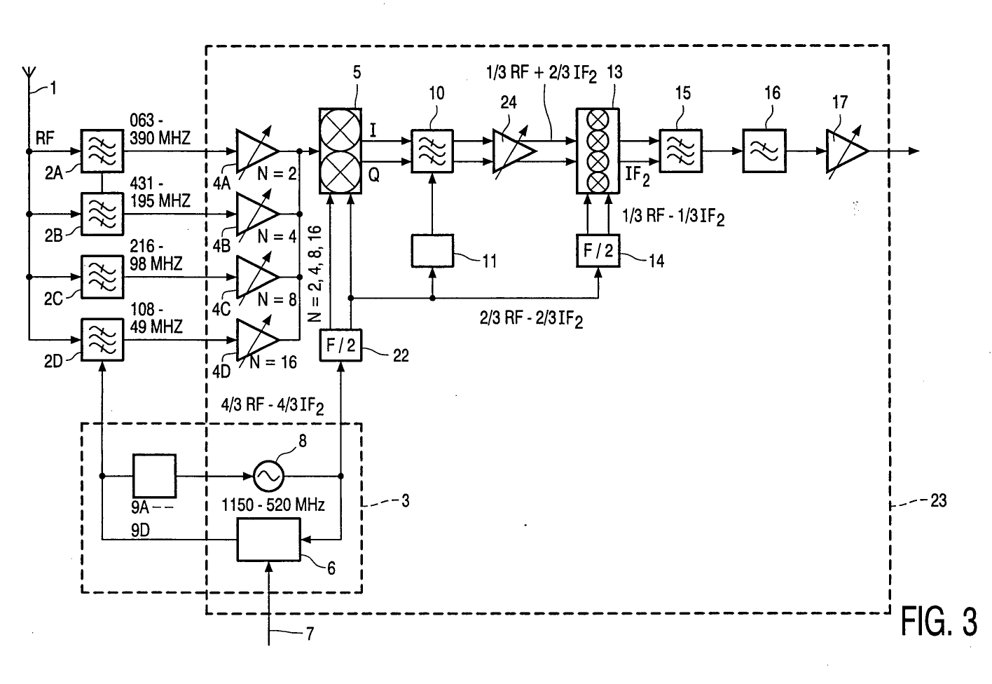

FIG. 3 shows a third embodiment;

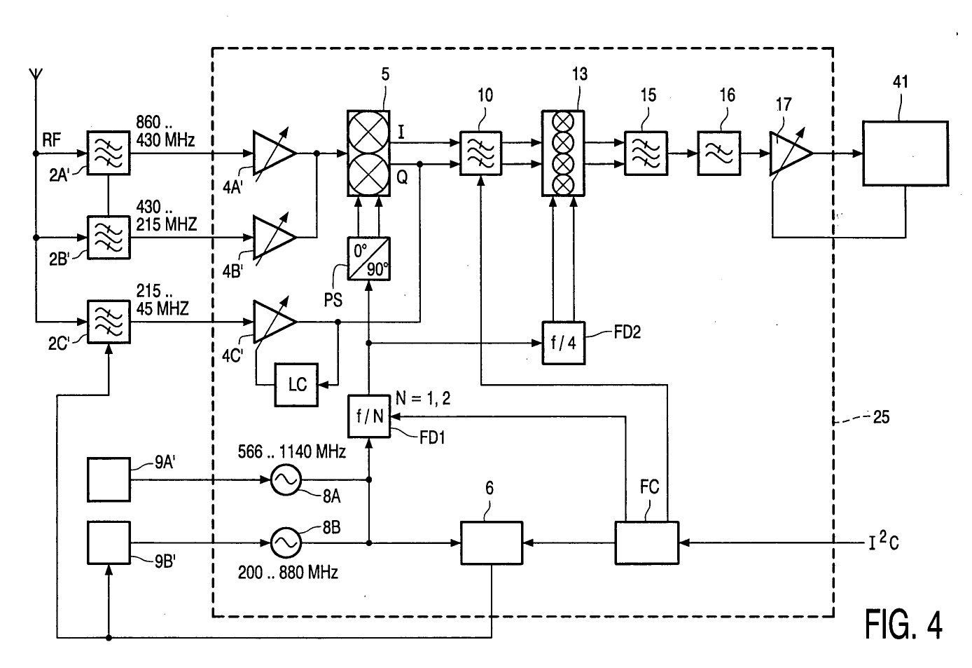

FIG. 4 shows an embodiment of a six-mixer analog front-end for terrestrial use in accordance with the present invention;

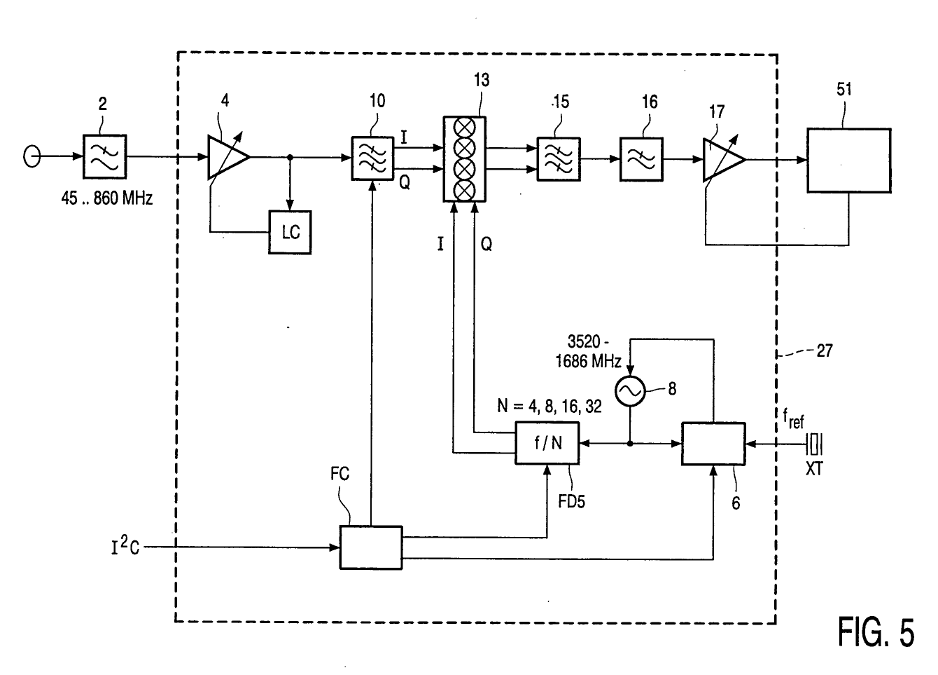

FIG. 5 shows an embodiment of a four-mixer analog front-end for cable use in accordance with the present invention; and

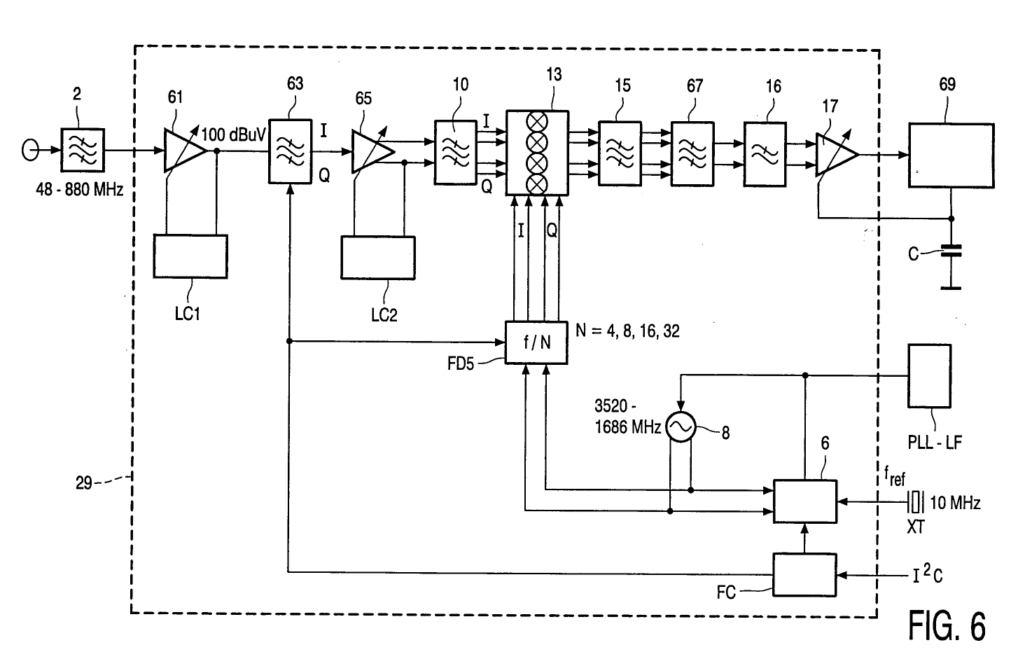

FIG. 6 shows another embodiment of a four-mixer analog front-end for cable use in accordance with the present invention.

In the TV-tuner circuit according to FIG. 1, an antenna 1 supplies a RF signal to a band-pass tracking filter 2. This filter 2 may be of a usual and prior art structure and has been maintained in view of adaptation of the antenna input to the first stage of the tuner and the high IP2 requirement in view of high dynamic range requirements. This requirement implies that the distortion of two strong incoming signals is not allowed to generate distortion products that might affect the reception of other, weaker signals. The filter 2 comprises e.g. one single tuned circuit having a Q in the order of magnitude of 6. This tuner circuit can perform the impedance adjustment for the required frequency. The tuning of the tuned circuit may take place in conventional manner by means of a varicap. The control voltage for this varicap is derived from the PLL local oscillator (LO) 3, more especially from its tank circuit 9, to be described later.

A low noise automatic gain control amplifier 4 serves for maintaining a constant output level. This amplifier 4 is provided with two optionally balanced outputs, i.e. four terminals. It is noted that the input stage of the variable amplifier 4 may substantially correspond with discrete prior art input circuits which are of high quality per se.

An RF quadrature mixer or half complex mixer 5 converts the signal to a polyphase signal of almost ⅓ of the reception frequency. In this context, “half complex” means that its input signal is a real signal, while its output signal is a complex signal having a real component I and a imaginary component Q. In this embodiment the output of mixer 5 controls the gain of the variable gain amplifier 4. Alternatively, this control may take place by the output of amplifier 4. The frequency of the local oscillator 3 is about 4/3 times the received frequency and a 0° and 90° shifted version of the local oscillator signal is supplied to mixer 5. It is noted that in the FIG. 3 embodiment the LO frequency is 4/3×N/2, N being 2, 4, 8, 16. In the embodiment of FIG. 1, the signal processing is based on undermixing (LO<RF, viz. ⅔ RF). In view of the frequency position of spurious signals preference is given to uppermixing (LO>RF, viz. 4/3 RF) shown hereinafter.

The PLL local oscillator 3 comprises a synthesizer 6 having a control input 7 to be provided with control signals by a user. The output frequency of the synthesizer is different from prior art TV-tuner synthesizers. However, the basic concept of the circuit is substantially the same as according to the prior art. As shown, the local oscillator 3 comprises synthesizer 6, an oscillator 8 and, in this embodiment, one single tank or LC-resonator 9, the capacitance being implemented as a varicap matched with the varicap present in tracking filter 2. The I and Q output signals of half complex mixer 5 are supplied to a controlled first-IF low-pass filter (not shown) and a polyphase filter 10 to suppress negative frequencies. This filter 10 is controlled by a band selecting tracking control circuit 11 which in its turn is controlled by a frequency divider 12 receiving a local oscillator signal from local oscillator 3 to 0° and 90°, respectively, signals outputted from frequency divider 12 are supplied to mixer 5 as control signals. The outputs of band-pass filter 10 having a frequency of ⅓ RF+⅔ IF2 are supplied through an optional adjustable amplifier 24 to a fully complex IF mixer 13 controlled by a second frequency divider 14 which in its turn is controlled by the same control signal as tracking control circuit 11 by a signal having frequency of ⅔ RF−⅔ IF2. In this context, a fully complex mixer means that both its input signal and its output signal are complex signals having real and imaginary components. The output of IF2 of IF mixer 13 is filtered in a polyphase filter 15. This filter 15 serves the purpose of removing the image frequencies of mixer 13 by suppressing the negative frequencies from the polyphase signal. The polyphase filter 15 may further be provided with a group delay correction assembly. If necessary, in view of the dynamic range of the integrated filter 15, some selectivity may be used. In that case also a further reduction of dynamics may be applied by the use of an automatic gain control amplifier. To prevent aliasing and to limit the required dynamic range in a following A/D converter, polyphase filter 15 is followed by a low-pass filter 16 and controlled amplifier 17.

The polyphase filter 15 in the IF2 signal path suppresses the negative frequencies of the received signal. The IF2 frequency is chosen in a way such that in case of reception of a conventional analog TV signal the picture carrier wave has a frequency of about 1 MHz; the center of the TV signal is shifted to about 5 MHz. For a correct suppression a good matching, phase difference 90° and equal amplitudes of the I and Q paths are necessary. Compared to a half complex mixer, requirements for the LO I/Q matching can be relaxed by using a full complex mixer in combination with polyphase filter 10 in front of the full complex mixer 13. After having passed the polyphase filter 15 and if necessary a group delay corrector, the signal passes through the conventional low-pass filter 16. The low-pass filter 16 and the controlled amplifier 17 are used to prevent aliasing and to limit the required dynamic range in the following A/D converter. The low-pass filter 16 is followed by an automatic gain control amplifier 17 controlled by a level detector e.g. connected with the output of an analog/digital-converter (not shown).

It will be apparent that the FIG. 1 embodiment uses a six-mixer architecture in order to obtain high image rejection at the second IF. The tracking antenna filter 2 is, in this embodiment, used in order to meet the high dynamic range requirements necessary for terrestrial reception. It is important to note that no ceramic or SAW (surface acoustic wave) filters are used.

The dashed boundary frame 18 indicates the integrated circuit forming an integral part of the TV-tuner circuit. IC 18 is a separate part that will be made commercially available.

In FIGS. 2 and 3, parts corresponding to parts of FIG. 1 are indicated with the same reference numerals.

In FIG. 1, undermixing is used, i.e. the frequency divider 12 provides an output frequency divided by two relative to the local oscillator frequency. Thus LO<RF. This is the principle of under mixing.

The FIG. 2 embodiment uses upper mixing according to which LO>RF. To this end, use is made of a phase splitter 19 provided 0° and 90° signals. Furthermore instead of the two-divider 14 according to FIG. 1, a four-divider 20 is used in the FIG. 2 embodiment.

Frame 21 indicates the IC according to the present embodiment.

FIG. 3 shows an alternative embodiment in which four tracking filters 2A, 2B, 2C, 2D are used corresponding to four tank circuits 9A, 9B, 9C and 9D, or alternatively one tank circuit. The outputs of tracking filters 2A-2D are connected with automatic gain control circuits 4A, 4B, 4C, 4D, respectively. In this embodiment the frequency ranges of the A, B, C and D parts correspond to 863-390 MHz, 431-195 MHz, 216-98 MHz, 108-49 MHz.

Frequency divider 22 may be adjusted for division by 2, 4, 8, and 16, corresponding to respectively paths A, B, C and D.

Frame 23 indicates the integrated circuit.

It is novel that in accord with the invention the controlled RF amplifiers 4 and 4A, 4B, 4C, 4D amplifiers form part of the integrated circuit 18, 21, 23.

After the second mixing stage a low IF follows. It is noted that in view of the second order distortion and 1/f noise a low IF is preferable to zero-IF. Application of this concept for TV-tuner according to the invention is novel.

Compared to a half complex mixer, requirements for the LO I/Q matching can be relaxed by using a full complex mixer in combination with polyphase filter in front of the full complex mixer. The IF signal is after the first mixing stage purified by means of a polyphase filter; the local oscillator signal is 0° and 90°. In a prior art six-mixer concept no polyphase filter 10 between the mixing stages 5, 13 is present. Also this aspect according to the invention is novel relative to prior art.

Dividing the first local oscillator frequency with a factor 4 (FIG. 2) in order to generate the second local oscillator signal is known per se but is has never been used for TV-tuners. This is also the case for the filtering of the low IF signal with a polyphase filter suppressing the lower adjacent component.

FIG. 4 shows yet another embodiment of a six-mixer analog front-end in accordance with the present invention. It shows some slight variations with regard to the embodiment of FIG. 3, such as another distribution of the tracking RF antenna filters 2A′, 2B′ and 2C′, a number (2) of tanks 9A′, 9B′ that differs from the number (3) of antenna filters 2A′, 2B′ and 2C′, and using a I2C signal to control various parts in the IC via a frequency control circuit FC. Gain control circuits 4A′, 4B′ and 4C′ are connected in series to the antenna filters 2A′, 2B′ and 2C′. Outputs of the gain control circuits 4A′ and 4B′ are combined and applied to the RF mixer 5. The gain of the gain control circuit 4C′ is controlled by a level control circuit LC having an input that is connected to an output of the gain control circuit 4C′, which is combined with the Q output of the RF mixer 5. Outputs of the tank circuits 9A′, 9B′ are applied to oscillators 8A and 8B, respectively, combined outputs of which being applied to the synthesizer 6. The output of the synthesizer 6 is applied to both tank circuits 9A′, 9B′. The frequency control circuit FC controls the synthesizer 6, and a first frequency divider FD1 connected to the combined outputs of oscillators 8A, 8B, and provides a band select signal to the tracking polyphase filter 10. An output of the first frequency divider FD1 is applied to a phase splitter PS controlling the RF mixer 5, and to a second frequency divider FD2 controlling the IF mixer 13. An output of the controllable amplifier 17 is applied to a digital front-end and analog multi-standard decoder 41, from which a control signal for the controllable amplifier 17 is obtained.

A preferred embodiment of the six-mixer circuit can be summarized as follows. TV-tuner circuit using double conversion and having a six mixer architecture, the TV-tuner circuit comprising a series connection of an antenna input, at least one RF tracking filter (2), a controlled RF amplifier (4) having one input and one output, a half complex or quadrature mixer (5) having two outputs I and Q, a controlled (optional) first IF low-pass filter and polyphase filter (10) having two inputs and two outputs, a fully complex mixer (13) having two inputs and two outputs IF2, a polyphase filter (15) having two inputs and at least one output, a low-pass filter (16) having one input and one output, a controlled second-IF amplifier (17) having one input and one output, a local oscillator (3) comprising at least one tank circuit (9) associated to the at least one RF tracking filter (2), a synthesizer (6) connected to control means for control by a user, and an oscillator (8), the local oscillator (3) controlling the at least one RF tracking filter (2) the half complex filter (5) through a first frequency divider (12) or a phase shifter having two outputs, the controlled first-IF low-pass and polyphase filter (10) through a tracking control circuit (11), the fully complex mixer (13) through a second frequency divider (14) having two outputs. Part of the tuner circuit takes the form of an integrated circuit (18, 21, 23), the part comprising the controlled RF amplifier (4), the half complex mixer (5), the controlled first-IF low-pass and polyphase filter, the fully complex mixer (13), the polyphase filter (15), the low-pass filter (16), the controlled second-IF amplifier (17), the synthesizer (6), the oscillator (8), the first frequency divider (12) or phase shifter, the tracking control circuit (11), and the second frequency divider (14).

FIG. 5 shows an embodiment of a four-mixer analog front-end for cable use in accordance with the present invention. This embodiment shows the three most essential elements of the invention, viz. a first polyphase filter 10 at the input side of a fully complex mixer 13, and a second polyphase filter 15 at the output of the fully complex mixer 13.

The I2C-controlled frequency control circuit FC controls a frequency divider FD5 that controls the mixer 13. The synthesizer 6 is receives a reference frequency f_{ref} from a crystal XT. The controllable amplifier 17 receives a level control signal from the digital front-end and channel decoder 51.

FIG. 6 shows another embodiment of a four-mixer analog front-end for cable use in accordance with the present invention. The embodiment comprises successively a controllable input amplifier 61, an RF band-pass filter 63, an optional controllable amplifier 65, an RF polyphase filter 10 to supply an in-phase and a quadrature signal to a polyphase mixer 13 that comprises four double balanced mixers, where the output of the mixer 13 supplies a low IF signal (between 1 and 10 MHz, e.g. at 1.7 MHz) with sufficient accuracy, suited for A/D conversion and further digital processing. The controllable amplifier 61 is a broadband amplifier that can be controlled in steps of e.g. 10 dB. A first level control circuit LC1 is coupled between an output and a control input of the amplifier 61. The band-pass filter 63 prevents frequencies around the fifth harmonic of the local oscillator (LO) frequency from being input to the mixer 13, and it reduces the number of undesired channels. The reason for the RF bandpass filter 65 is that the mixer 13 should multiply by sinus functions, but does multiply by block functions comprising higher harmonics that would mix other components in the mixer input signal down as well. The RF bandpass filter 63 prevents those other component from being in the mixer input signal. The function of the RF bandpass filter 63 may be combined with that of the RF polyphase filter 10.

The optional controllable amplifier 65 brings the signal at the desired level. A second level control circuit LC2 is coupled between an output and a control input of the amplifier 65. The RF polyphase filter 10 furnishes an in-phase and a quadrature version of the signal that is applied to the full polyphase mixer 13. In the low-IF signal the neighboring upper or lower channel is present between the band of −10 MHz to −1 MHz. In view of the selectivity requirements, the negative frequencies must be removed from the polyphase low-IF signal before it can be converted into a normal, non-polyphase signal. Subsequently, polyphase group delay equalization (correction) 67, anti-alias filtering 16, and an automatic gain control 17 for the A/D conversion in the digital front-end and channel decoder 69 are carried out. The decoder 69 supplies a control signal to the amplifier 17, which is stored in a capacitor C. The decoder 69 may be the IC TDA10021.

The polyphase group delay correction 67 is positioned between the IF polyphase filter 15 and the IF low-pass filter 16 because group delay correction can be carried out in a simple manner when the signal is polyphase. The group delay correction 67 compensates for frequency-dependent delays introduced by the IF polyphase filter 15 and the IF low-pass filter 16.

The polyphase filter 10 prior to the mixer 13, and the use of a full polyphase mixer 13 are needed to achieve the desired accuracy of the polyphase low-IF signal. The extent to which filtering is needed depends on the mutual equality and phase accuracy of the signals in the low-IF signal. Using a full polyphase filter 10, a polyphase RF signal, and a complex local oscillator signal allows for a realization of the mutual equality that is required for the filtering. A second function of the RF polyphase filter 10 is to prevent mixing products from being present in the low-IF signal as a result of the third harmonic of the local oscillator signal.

The final automatic gain control stage 17 is desired in view of the dynamic range of the A/D converters. The synthesizer 6 and the frequency control circuit FC may be implemented as in the prior art. A PLL loop filter PLL-LF is connected to the synthesizer 6 and the oscillator 8.

It should be noted that the above-mentioned embodiments illustrate rather than limit the invention, and that those skilled in the art will be able to design many alternative embodiments without departing from the scope of the appended claims. Instead of a tracking polyphase filter, a fixed polyphase filter or a band-switched polyphase filter (a polyphase filter in combination with on/off switchable low-pass filters) is possible. The latter option is indicated by controlled (optional) first IF low-pass filter and polyphase filter. The number of tank circuits does not need to be equal to the number of antenna filters, as one tank circuit may belong to two or more antenna filters. The number of tank circuits is between one and the number of antenna filters.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

1. An integrated tuner circuit (18, 21, 23, 25, 27, 29) comprising:
a first polyphase filter (10) having a complex output;
a fully complex mixer (13) having a complex input coupled to a complex output of the polyphase filter (10); and
a second polyphase filter (15) having a complex input coupled to a complex output (IF2) of the fully complex mixer (10).

2. An integrated tuner circuit as claimed in claim 1, further comprising a half complex mixer (5) having a real input, and a complex output (I, Q) coupled to a complex input of the first polyphase filter (10).

3. An integrated tuner circuit as claimed in claim 1, further comprising a low-pass filter (16) having an input coupled to an output of the second polyphase filter (15).

4. An integrated tuner circuit as claimed in claim 1, further comprising an RF bandpass filter (63) between an input of the integrated tuner circuit and an input of the polyphase filter (10).

5. An integrated tuner circuit as claimed in claim 1, further comprising a polyphase group delay correction circuit (67) coupled to a polyphase output of the second polyphase filter (15).

6. A tuner module comprising:
an RF filter (2) coupled to receive an input signal; and
an integrated tuner circuit (18, 21, 23, 25, 27, 29) as claimed in claim 1 coupled to an output of the RF filter (2).

7. A television signal receiver comprising a tuner module as defined by claim 6.
